(19) United States
(12) Patent Application Publication
(10) Pub. No.: US 2004/0230456 A1
(43) Pub. Date: Nov. 18, 2004

(54) System for identifying candidates for ICD implantation

(76) Inventors: Luke R. Lozier, Stillwater, MN (US); F. Roosevelt Gilliam III, Hopewell, VA (US); Robert J. Johnson JR., Lakeville, MN (US); Scott Gervais, Cottage Grove, MN (US); Sarah Webber, White Bear Lake, MN (US); Carlos Roman, Andover, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/438,261

(22) Filed: May 14, 2003

(51) Int. Cl. G06F 17/60

(52) U.S. Cl. 705/2; 705/3

(57) ABSTRACT

A software system for identifying patients who may be appropriate candidates for implantation with an implantable cardioverter/defibrillator (ICD) is disclosed. The system particularly identifies those patients who are at increased risk for sudden cardiac death based upon a history of a prior heart attack and left ventricular dysfunction.

### FIELD OF THE INVENTION

This invention pertains to methods and systems for assisting clinicians in providing care to cardiac patients.

### BACKGROUND

Sudden cardiac death (SCD) is death resulting from an abrupt loss of heart function, referred to as cardiac arrest, and is one of the most common causes or mortality in the United States. The victim may or may not have diagnosed heart disease, and death can occur within minutes after symptoms appear. The most common underlying reason for patients to die suddenly from cardiac arrest is coronary heart disease, but many heart diseases can lead to cardiac arrest and sudden cardiac death. Most of the cardiac arrests that lead to sudden death occur when the electrical impulses in the diseased heart become rapid (referred to as ventricular tachycardia) or chaotic (referred to as ventricular fibrillation) or both. SCD results when the irregular heart rhythm or arrhythmia depresses cardiac function to such an extent that life can no longer be sustained.

Implantable cardioverter/defibrillators (ICDs) were originally developed and have been most frequently used for prevention of sudden cardiac death in patients with a history of life-threatening ventricular arrhythmias such as sustained ventricular tachycardia (VT) or ventricular fibrillation (VF). An ICD is a battery-powered device which is implanted sub-pectorally on a patient's chest without the need for a thoracotomy. An ICD has one or more leads which are threaded intravenously into the heart to connect the device to electrodes used for sensing cardiac electrical activity and for delivering electrical energy to the heart in order to terminate the arrhythmia. Arrhythmias such as VT and VF are detected and distinguished by measurement of the interval between successive ventricular beats as determined from sensed electrical activity. Depending upon the type of arrhythmia, an ICD may terminate the arrhythmia by either delivering a high-energy defibrillation shock, a low-energy cardioversion shock, or anti-tachycardia pacing.

Clinical studies have firmly established that ICDs are indicated in patients with a history of life-threatening sustained VT or VF. Subsequent studies, however, have also established that ICDs are beneficial as prophylactic therapy, i.e, in patients who are at risk for SCD but who have not yet manifested sustained ventricular arrhythmias. The Multicenter Automatic Defibrillator Implantation Trial (MADIT) showed a significant survival benefit in patients with depressed left ventricular function as determined by a measured ejection fraction (EF) less than 35%, spontaneous nonsustained VT, and inducible sustained VT or VF during electrophysiologic studies (EPS). The Multicenter Automatic Defibrillator Implantation Trial-2 (MADIT-2) markedly expanded the potential pool of ICD recipients by establishing that ICD therapy is beneficial for patients having a history of prior myocardial infarction (MI) and an EF less than or equal to 30%, irrespective of the occurrence of inducible VT during EPS.

### SUMMARY

The present invention relates to a computer software system for aiding in the identification of patients who are appropriate candidates for ICD implantation, particularly those patients who meet the MADIT-2 criteria or may need further electrophysiological studies. Patient records are maintained in a local database with clinical data entered into the records as it is generated. The system then analyzes the data and presents the information derived therefrom in a manner which flags particular data fields in the patient records in order to prompt further appropriate action. The system also provides a means by which multiple centers may pool their clinical data by synchronizing their databases via an internet or other network connection.

### BRIEF DESCRIPTION OF THE DRAWINGS

FIG. 1 illustrates the basic architecture of two exemplary systems connected over a network.

FIG. 2 illustrates the data fields of an exemplary patient record.

FIG. 3 shows an example data presentation window.

### DETAILED DESCRIPTION

The following description is of a software system for aiding clinicians in the selection of patients suitable for ICD implantation. In particular, the system systematically identifies patients who may be at increased risk for SCD based upon a history of a prior heart attack and left ventricular dysfunction. A user enters data for required fields into the system, with the software adapting by activating, deactivating, adapting, and/or changing colors of affected fields, adhering to the algorithms that govern the system's behavior. The system then culls out those patient records that should be considered for stratification of SCD risk. Additional data fields are completed for these patients, interactively guiding the user through the differential diagnosis cascades used to manage the risk of SCD (e.g. the MADIT-II indication). Through differing levels of privileges, electronic signatures may also be applied to the data fields to certify them as source data. Further, data records may be de-identified to minimize the risk of patient privacy violations while applying a globally unique registry number to each record. Data can be securely synchronized/refreshed with a central server or other local system at any time through an active internet or other network connection.

In one embodiment, the software can be installed as a core center or as a satellite of a core center. When a satellite center performs a refresh, it will exchange all information for its own center, but not receive information from any other center. When a core center performs a refresh, it will exchange all information for its own center, and all information from all its satellite centers will be downloaded to the core center. This allows a core center to map its entire referral network in a hub/spoke method.

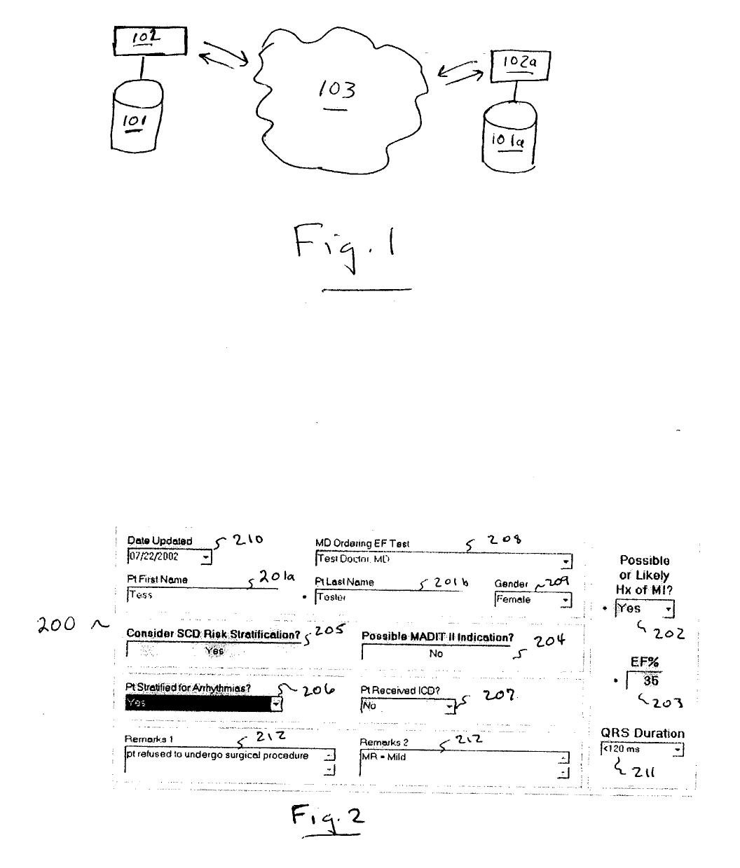

FIG. 1 illustrates an exemplary software system which may be conceptualized as being made up of two primary components, a local database 101 for storing a plurality of patient records (a.k.a., a patient registry) and a clinical data manager 102 for providing a user interface to the local database by which a user may add, delete, and modify patient records. The clinical data manager also provides logic to analyze the patient records and present information derived therefrom to the user. Also shown in the figure is an exemplary remote system having a database 101a and clinical data manager 102a. The remote system 101a/102a may be a peer of the local system 101/102 or may be a central core center communicating with a plurality of satellite systems similar to the system 101/102. The clinical data manager of each system may further include client/server software for communicating over the network 103 in order to enable the patient records in the local database to be synchronized with a remote database or the patient records of the remote database to be synchronized with the local database. Multiple clinical centers may possess their own local systems and pool their clinical data in this manner in order to provide for more effective screening of their common patients.

Each patient record has a plurality of data fields which contain data either entered by the user or calculated by the system. An example of a patient record is illustrated in FIG. 2 as it appears in a presentation window 200 generated by the software. The patient record has user-enterable data fields 201a and 201b for containing a patient identifier which identifies a particular patient associated with the record. This field uniquely identifies the patient record and thus constitutes a primary key for the database. The patient identifier may be the patient's name or, in order to preserve confidentiality when the records are transmitted to another center's database, may be a secret code which uniquely identifies the patient. Another user-enterable data field 202 in the patient record is for containing an indicator as to whether the patient associated with the record has a history of myocardial infarction (MI), where the value of the field is either “yes” or “no.” The measured ejection fraction (EF) of the patient associated with the record is contained in another a user-enterable data field 203. The data fields 202 and 203 thus encapsulate the data needed to ascertain whether or not the patient meets the MADIT-2 criteria for ICD implantation discussed above. A calculated data field 204 in each patient record indicates whether the patient meets the MADIT II criteria or not, wherein the value of the MADIT II criteria field is “yes” if the patient has a history of MI and the patient's EF is less than or equal to 30%, and “no” otherwise;

The system also maintains a user-defined variable designated EF-CEILING for representing the value of an EF below which left-ventricular dysfunction is considered to exist. Users may set the value of EF-CEILING to whatever value is deemed appropriate in view of their own experience or the results of external clinical studies. Together with the history of MI data field 202 and the EF data field 203, the EF-CEILING variable allows patients who do not meet the MADIT-2 criteria but are nevertheless at risk for sudden cardiac death (SCD) to be identified. A calculated SCD risk data field 205 indicates whether the patient is at risk for sudden cardiac death, where the value of the SCD risk field is “yes” if the patient has a history of MI and the patient's EF is less than EF-CEILING, and “no” otherwise. Patients who are at risk for SCD but do not meet the MADIT-2 criteria should be evaluated further to see if they can meet another established indication for ICD implantation. Another data field 206 is thus provided in each patient record for indicating whether the patient has been stratified for arrhythmias by electrophysiological monitoring, where the value of the stratified for arrhythmias field is user-enterable to be either “yes” or “no” only if the SCD risk field is “yes” and the MADIT II criteria field is “no,” and is inactive otherwise.

A data field 207 is provided in each patient record for indicating whether or not the patient has received an ICD. This field is active and can be set by the user only if the data indicates that ICD implantation is appropriate for the patient. Thus, the value of the received ICD field is user-enterable to be either “yes” or “no” only if: 1) the MADIT II criteria field is “yes” or 2) the stratified for arrhythmias field is “yes,” and inactive otherwise. The system of claim 1 further comprising a user-enterable data field in each patient record for containing a gender designation of the patient associated with the record.

Other data fields for containing potentially useful information may also be provided in the patient record. In the example shown in FIG. 2, a user-enterable data field 208 is provided for containing an identifier of the physician ordering an EF test for the patient associated with the record, a user-enterable data field 210 is provided for containing a date on which the patient record was last updated, and a user-enterable data field 209 is provided for containing a gender designation of the patient associated with the record. Another data field 211 is provided for containing a measured QRS duration of the patient associated with the record. A wide QRS duration may indicate the presence of a ventricular conduction abnormality which can be appropriately treated with cardiac resynchronization therapy concomitant with ICD therapy. Finally, one or more remarks fields 212 are provided for entering any textual or numeric data which the user desires.

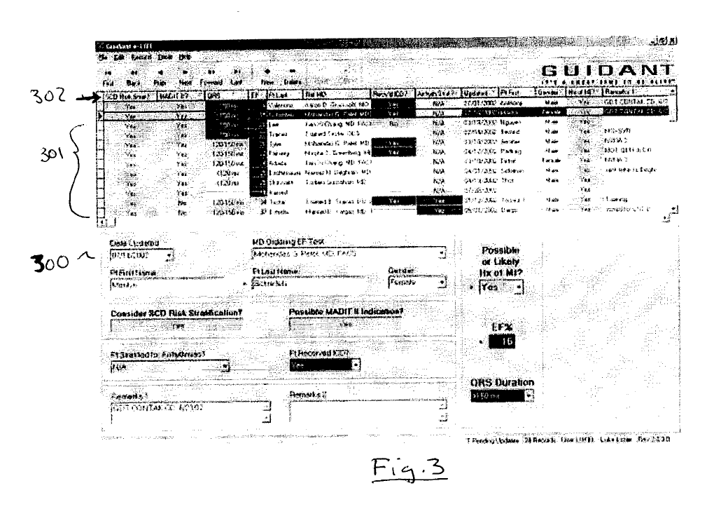

FIG. 3 illustrates an example presentation window 300 which the clinical data manager uses to display data to the user and obtain user input. A plurality of patient records 301 are displayed in the upper portion of the window 300, each such record with its data field values constituting a separate row. The corresponding data fields of each patient record are thus grouped into columns designated by column headers 302. The bottom portion of the window 300 displays the data field values of a selected patient record (e.g., by highlighting the record with a mouse click) and enables certain values of that record to be changed by the user. The system also allows the user to configure the clinical data to sort the patient records in a desired order based upon the values contained in particular data fields by rearranging the column headers 302. Each column header 302 represents one of the data fields in a patient record. The patient records are sorted in the upper portion of the presentation window according to their values in the data field designated by the left-most column header. By dragging and dropping the column headers with a mouse, the user may rearrange the column headers to sort the data records based upon the value of a selected data field. After initially sorting the records based upon the value of the left-most data field, records with identical values in the left-most data field are further sorted based upon the values of the next data field proceeding from left to right. This sorting process is repeated for the next data field column header and so on. This enables the clinical data manager to be configured by the user to present the patient records hierarchically sorted by selected data fields. Whether the sort order according to each column header is ascending or descending is also selectable by the user for each column header. Note that the remarks field is also represented by a column header, thus enabling the patient records to be sorted according to any type of user-selected data.

For example, suppose it is desired to identify patients who are candidates for both ICD and cardiac resynchronization therapy. The column headers could then be arranged in the following order:

| Column Header | Sort Order |
|---|---|
| SCD risk | descending |
| QRS duration | descending |
| EF | ascending |
| Patient ID | ascending |

The presentation window in the illustrated embodiment may also color-code certain data fields of a presented patient record according to the value of the data field. In one color-coding scheme, for example, green is used to indicate a normal condition, yellow is used to flag the data field for attention, red is used to flag the data field for highest attention, and gray is used to de-emphasize the data field or indicate that it is not active or editable. The EF data field of a presented patient record is color-coded according to whether the value contained in the field is less than or equal to 30% (red), greater than 30% but less than EF-CEILING (yellow), or greater than or equal to EF-CEILING (green). The received ICD field of a presented patient record is color-coded according to whether the value contained in the field is yes (green), no (yellow), or inactive (gray). The stratified for arrhythmias field of a presented patient record is color-coded according to whether the value contained in the field is yes (green), no (yellow), or inactive (gray). The SCD risk field of a presented patient record is color-coded according to whether the value contained in the field is yes (yellow) or no (gray). The MADIT II criteria field of a presented patient record is color-coded according to whether the value contained in the field is yes (yellow) or no (gray).

The clinical data manager also allows the user to create reports in which the clinical data from the database is organized according to standard relational database queries. Thus, the user may select for display only those patient records having values in selected data fields that meet certain criteria. In this manner, different snapshots of the patient registry may be obtained based upon the values contained in the data fields. For example, a user may want to print out or display only those patient records which reflect that the patient meets the MADIT II criteria but has not received an ICD. In another example, a report may generated that selects only those patient records which reflect that the patient meets the MADIT II or other criteria for ICD implantation, has not received an ICD, and has a QRS duration greater than a specified amount. In a particular embodiment, the patient records in such a report are sorted in accordance with the column headers in the presentation window as described above.

Although the invention has been described in conjunction with the foregoing specific embodiments, many alternatives, variations, and modifications will be apparent to those of ordinary skill in the art. Other such alternatives, variations, and modifications are intended to fall within the scope of the following appended claims.

What is claimed is:

1. A software system for aiding in the identification of patients suitable for implantation with an implantable cardioverter/defibrillator (ICD), comprising:
a local database for storing a plurality of patient records, wherein each patient record has a plurality of data fields;
a clinical data manager for providing a user interface to the local database by which a user may add, delete, and modify patient records and for providing logic to analyze the patient records and present information derived therefrom to the user;
a user-enterable data field in each patient record for containing a patient identifier which identifies a particular patient associated with the record;
a user-enterable data field in each patient record for containing an indicator as to whether the patient associated with the record has a history of myocardial infarction (MI);
a user-enterable data field in each patient record for containing a measured ejection fraction (EF) of the patient associated with the record;
a user-defined variable designated EF-CEILING for representing the value of an EF below which left-ventricular dysfunction is considered to exist;
a calculated data field in each patient record for indicating whether the patient is at risk for sudden cardiac death (SCD), wherein the value of the SCD risk field is “yes” if the patient has a history of MI and the patient's EF is less than EF-CEILING, and “no” otherwise;
a calculated data field in each patient record for indicating whether the patient meets the MADIT II criteria for ICD implantation, wherein the value of the MADIT II criteria field is “yes” if the patient has a history of MI and the patient's EF is less than or equal to 30%, and “no” otherwise;
a data field in each patient record for indicating whether the patient has been stratified for arrhythmias by electrophysiological monitoring, wherein the value of the stratified for arrhythmias field is user-enterable to be either “yes” or “no” only if the SCD risk field is “yes” and the MADIT II criteria field is “no,” and is inactive otherwise; and,
a data field in each patient record for indicating whether or not the patient has received an ICD, wherein the value of the received ICD field is user-enterable to be either “yes” or “no” only if: 1) the MADIT II criteria field is “yes” or 2) the stratified for arrhythmias field is “yes,” and inactive otherwise.

2. The system of claim 1 wherein the clinical data manager further comprises client/server software for communicating over a network and enabling the patient records in the local database to be synchronized with a remote database or to synchronize the patient records of the remote database with the local database.

3. The system of claim 1 further comprising a user-enterable data field in each patient record for containing a measured QRS duration of the patient associated with the record.

4. The system of claim 1 wherein the clinical data manager may be configured by the user to sort the data records for presentation in an order based upon the value of a selected data field.

5. The system of claim 1 wherein a data field of a presented patient record is color-coded according to the value of the data field.

6. The system of claim 5 wherein the EF data field of a presented patient record is color-coded according to whether the value contained in the field is less than or equal to 30%, greater than 30% but less than EF-CEILING, or greater than or equal to EF-CEILING.

7. The system of claim 5 wherein the received ICD field of a presented patient record is color-coded according to whether the value contained in the field is yes, no, or inactive.

8. The system of claim 5 wherein the stratified for arrhythmias field of a presented patient record is color-coded according to whether the value contained in the field is yes, no, or inactive.

9. The system of claim 5 wherein the SCD risk field of a presented patient record is color-coded according to whether the value contained in the field is yes or no.

10. The system of claim 5 wherein the MADIT II criteria field of a presented patient record is color-coded according to whether the value contained in the field is yes or no.

11. The system of claim 1 further comprising a user-enterable data field in each patient record for containing a gender designation of the patient associated with the record.

12. The system of claim 1 further comprising a user-enterable data field in each patient record for containing an identifier of the physician who ordered an EF test for the patient associated with the record.

13. The system of claim 1 further comprising a user-enterable data field in each patient record for containing a date on which the patient record was last updated.

14. The system of claim 1 wherein the clinical data manager may be configured by the user to present the patient records hierarchically sorted by selected data fields.

15. The system of claim 1 wherein the patient identifier field of each patient record contains the name of the patient associated with the record.

16. The system of claim 1 wherein the patient identifier field of each patient record contains a secret identifying code for the patient associated with the record.
